(19) United States
(12) Patent Application Publication
(10) Pub. No.: US 2022/0189039 A1
(43) Pub. Date: Jun. 16, 2022

(54) SYSTEM AND METHOD FOR CAMERA-BASED DISTRIBUTED OBJECT DETECTION, CLASSIFICATION AND TRACKING

(71) Applicant: CTY, INC. D.B.A. NUMINA, Brooklyn, NY (US)

(72) Inventors: RAPHAEL VIGUIER, Bronx, NY (US); TARA PHAM, Brooklyn, NY (US); MARTIN MCGREAL, St. Louis, MO (US); ILAN NATHAN GOODMAN, White Plains, NY (US)

(21) Appl. No.: 17/600,393

(22) PCT Filed: Mar. 29, 2020
(86) PCT No.: PCT/US20/25605

§ 371 Date: Sep. 30, 2021

Related U.S. Application Data
(60) Provisional application No. 62/830,234, filed on Apr. 5, 2019.

(51) Int. Cl. G06T 7/246; G06V 10/764; G06V 10/82; G06T 7/73; G06V 10/74; G06T 7/80; G06V 10/75; H04N 17/00; G06K 7/14

(52) U.S. Cl. CPC G06T 7/246; G06V 10/764; G06V 10/82; G06T 7/73; G06V 10/761; G06T 7/80; G01S 19/42; H04N 17/002; G06K 7/1417; G06T 2207/30241; G06T 2207/20084; G06T 2207/30232; G06T 2207/30236; G06V 10/757

(57) ABSTRACT

A camera-based system and method for detecting, classifying and tracking distributed objects moving along surface terrain and through multiple zones. The system acquires images from an image sensor mounted in each section or zone, classifies objects in the zone, detects pixel coordinates of the object, transforms the pixel coordinates into a position in real space, and generates a path of each object through the zone. The system further predicts a path of an object from a first cell for matching of criteria to objects in a second cell, whereby objects may be associated across cells based on predicted paths and without the need to storage and transmission of personally identifiable information.

### PRIORITY CLAIM

Applicant hereby claims priority to provisional U.S. patent application Ser. No. 62/830,234 filed Apr. 5, 2019, entitled “System and Method for Camera-Based Distributed Object Detection, Classification and Tracking.” The entire contents of the aforementioned application are herein expressly incorporated by reference.

### FIELD

The present disclosure relates to a method and system for camera-based detection, classification and tracking of distributed objects, and particularly to detecting, classifying and tracking moving objects along surface terrain through multiple zones without the transmission or storage of personally identifiable information.

### BACKGROUND

The detection, classification and tracking of objects through space has a wide variety of applications. One such common application is in the monitoring and analysis of traffic patterns of people, vehicles, animals or other objects over terrain, for example, through city and suburban roads and intersections.

The detection and tracking of objects across surface terrain using cameras has been possible using overhead camera, such as where the camera view angle is essentially perpendicular to the surface of the terrain being monitored. The ability to mount camera directly overhead however is frequently difficult and costly because there are few overhead attachment points or they are not high enough to take in a significant undistorted field of view. As an alternative it is possible to move the camera view angle off the perpendicular axis, such as for example, to place it on a lamp post along a road or at a street corner looking across the traffic area rather than down from overhead. As the camera angle deviates from the perpendicular, however, it becomes more difficult to identify the terrain surface and more particularly an object's path over the surface. One solution to this problem is to use multiple cameras to create stereoscopic vision from which the objects movement through space can be more readily calculated. This solution has drawbacks in that it requires multiple cameras for each area being monitored, greatly increasing hardware and installation costs.

In the particular field of traffic monitoring there are also more rudimentary systems known but they are lacking in capabilities and usefulness. For example, collecting data on the traffic patterns of an intersection has been known through manual counting, depth sensors (e.g., infrared, radar, lidar, ultra wide band), or the installation of a device such as a pneumatic road tube, a piezoelectric sensor or an inductive loop. Manual counting has safety risks associated with a human operator and the counter collects a smaller sample size than other methods. Depth sensors and inductive loops are expensive. Moreover, all of these methods lack the ability to classify objects and track object paths. Namely, these previous traffic monitoring methods and devices are limited in the amount of data they can collect. For example, it is difficult to distinguish between a truck and a car with the data from a pneumatic road tube. An inductive loop cannot track pedestrians or bicycles. Finally, it is difficult or impossible to combine and evaluate the data from multiple traffic sensors in a manner that produces meaningful data to track traffic patterns.

The problems of known systems become particularly acute when the area to be monitored is large, for example in monitoring the traffic patterns in an entire cityscape. Specifically, to assess, for example, the usage volumes of streets, cross walks, overpasses and the like and the pathways of the objects traversing the same over an entire cityscape the system needs to track objects from one sensor zone to another. Typically, only camera based systems have such capability to track paths but then can only track continuous paths from zones if the zones overlap and objects can be handed from one zone sensor to the other for tracking. This method however is exceedingly expensive as it requires full coverage of all areas without discontinuities.

### SUMMARY

The present disclosure solves the above needs and deficiencies with known methods of detecting, classifying and tracking distributed objects, such as is useful in vehicular and pedestrian traffic monitoring and prediction system and methods. For example, the method and system disclosed herein may use a single side mounted camera to monitor each zone or intersection, and track objects across multiple discontiguous zones while maintaining privacy; i.e., without storing or transmitting personally identifiable information about objects.

In a first aspect of the system a system and method are provided for detecting, classifying and tracking distributed objects in a single zone or intersection via a single camera with a field of view over the zone. The system and method includes tracking objects transiting an intersection using a single camera sensor that acquires an image of the zone or cell, classifies an object or objects in the image, detects pixel coordinates of the objects in the image, transforms the pixel coordinates into a position in real space and updates a tracker with the position of the object over time.

In a second aspect of the system and method, a plurality of zones or cells are monitored in a cityscape, wherein the plurality of zones may be discontiguous and do not overlap and wherein the paths from zone to zone are predicted through object characteristic and path probability analysis, without the storage or transfer of personally identifiable information related to any of the distributed objects.

A third aspect of the system and method is provided to configure and calibrate the sensor units for each zone using a calibration application running on a calibration device (e.g., mobile device/smartphone). The system and method includes mounting a sensor such that it can monitor a cell. A user scans a QR code on the sensor with a mobile device that identifies the specific sensor and transmits a request for an image to the sensor. The mobile device receives an image from the sensor and the user orients a camera on the phone to capture the same image as the sensor. The user captures additional data including image, position, orientation and similar data from the mobile device and produces a 3D structure from the additional data. The GPS position of the sensor or an arbitrary point is used as an origin to translate pixel coordinates into a position in real space.

While the disclosure above and the detailed disclosure below is presented herein by way of example in the context of a specific intersection, it will be understood by those of ordinary skill in the art that the concepts may be applied to other trafficked pathways where there is a beneficial advantage to track and predict traffic patterns of humans, animals, vehicles or other objects on streets, sidewalks, paths or other terrain or spaces. With the foregoing overview in mind, specific details will now be presented bearing in mind that these details are for illustrative purposes only and are not intended to be exclusive.

### BRIEF DESCRIPTION OF THE DRAWINGS

The accompanying drawings illustrate various non-limiting examples and innovative aspects of the system and method for camera-based detection, classification and tracking of distributed objects, calibration of the same and prediction of pathways through multiple disparate zones in accordance with the present description:

FIG. 1 is a diagram of a plurality of sensors monitoring multiple intersections.

FIG. 2 is a flow chart of a calibration process.

FIG. 3 is a schematic of a calibration arrangement and sweep pattern.

FIG. 4 is a schematic of the relative positioning of a mobile device.

FIG. 5 is a schematic of a homography transformation between image plane and ground plane.

FIG. 6 is a block diagram of the sensor detection and tracking modules.

FIG. 7 is an exemplary image of an intersection captured by a sensor with distributed object paths classified and tracked.

FIG. 8 is an exemplary image translation of the image of FIG. 7 translated to the ground plane.

FIG. 9 is an exemplary satellite image of the intersection of FIG. 7 with distributed object paths overlaid.

FIG. 10 is an exemplary image captured form the sensor with the base frames calculated and overlaid.

FIG. 11 is a block diagram of an object merging process.

### DETAILED DESCRIPTION

In simplified overview, an improved system and method for camera-based detection, classification, and tracking of distributed objects is provided, as well as, a system and method of calibrating the system, and predicting object paths across discontiguous camera view zones is described herein. While the concepts of the disclosure will be disclosed and described herein in the context or pedestrians and vehicles in a cityscape for ease of explanation, it will be apparent to those of skill in the art that the same principles and methods can be applied to many applications in which objects are traversing any terrain.

System Configuration

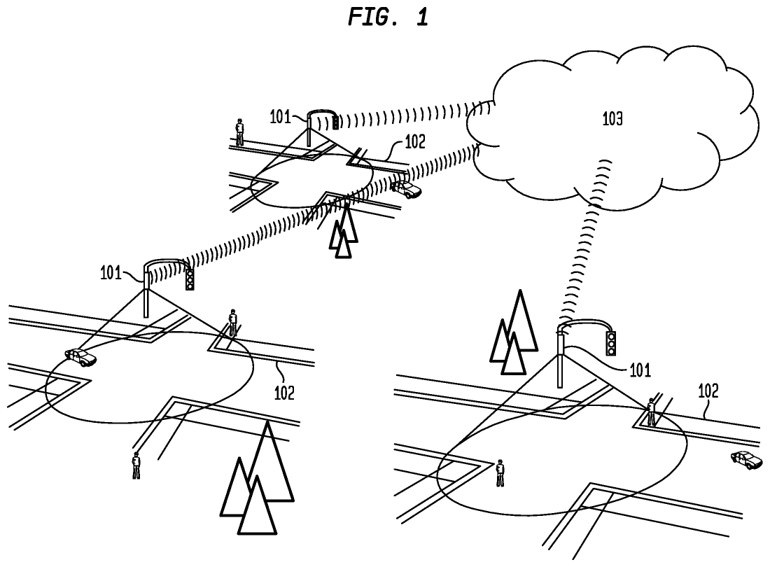

Referring to FIG. 1, one exemplary embodiment of the present disclosure provides systems and methods for tracking objects transiting a street intersection 102, a single sensor unit 101 may be used to monitor traffic through each cell or intersection 102 over one or more cells or intersections throughout a city scape. An image sensor is collocated with at least a microprocessor, a storage unit, and a wired or wireless transceiver to form each sensor unit 101. The image sensor has a resolution sufficient to allow the identification and tracking of an object. Furthermore, the image sensor uses a lens having a wide field of view without causing distortion. In an exemplary embodiment, the lens has a field of view of at least 90 degrees. The sensor unit 101 may also include a GPS receiver, speaker, or other equipment. The sensor unit 101 is preferably adapted to be mounted to a pole, wall or any similar shaped surface that allows the sensor unit 101 to overlook the intersection and provides an unobstructed view of the terrain to be monitored. The sensor unit 101 is mounted above the intersection 102 and angled down toward the intersection 102. The sensor unit 101 is mounted to allow the sensor unit 101 to observe the maximum area of the intersection 102. In an exemplary embodiment, the sensor unit 101 is mounted twenty feet above the intersection 102 and angled thirty degrees below the horizon.

In various embodiment, such as shown in FIG. 1, a plurality of discontiguous zones, cells or intersections 102 may be equipped with sensor units 101, and the sensor units 101 preferably may communicate non personally identifiable information regarding tracked objects in one zone to the sensor unit 101 monitoring an adjacent zone via a direct communication pathway or indirectly via a cloud computer 103.

Sensor Calibration

Before the image sensor in each sensing unit can accurately track objects in its view (e.g., the intersection), the sensing unit must be calibrated so that an image from a single camera unit (i.e., without stereoscopic images or depth sensors) can be used to identify the positions of the objects on the terrain in its view field.

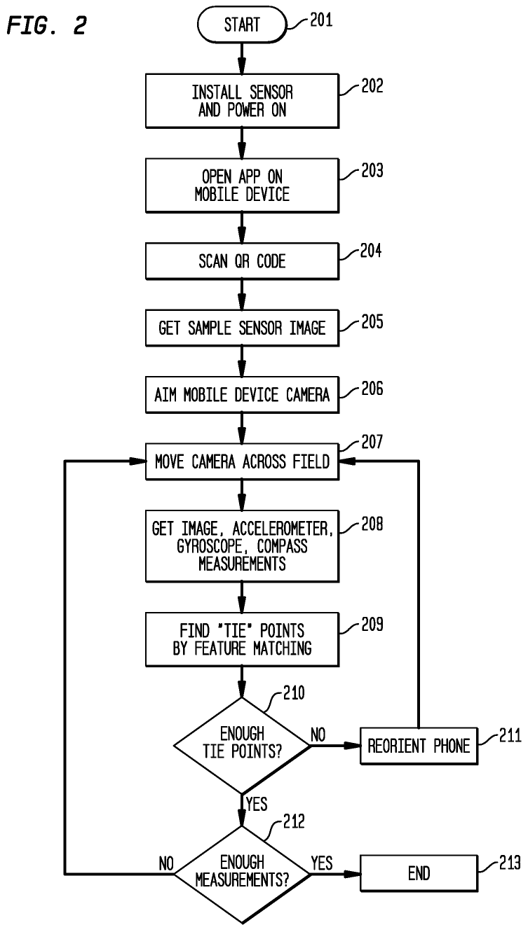

An exemplary method for calibrating the sensor unit is illustrated in the flow chart of FIG. 2. The calibration process is broken down into a measurement phase and a processing phase. A mobile device is preferably used by the system installer to collect measurement data (measurement phase) to be used in generating the calibration data (processing phase). The mobile device preferably includes a camera, accelerometer, gyroscope, compass, wireless transceiver and a GPS receiver, and accordingly many mobile phones, tablets and other handheld devices contain the necessary hardware to collect calibration data and can be used in conjunction with calibration software of the disclosure to collect the measurements for calibration.

Referring to FIG. 1, the calibration process 201 begins with the installation of the first sensor unit in an appropriate location 202 as described above. Once the sensor unit is properly mounted and wired for power, the sensor unit may be connected to the internet either by being wired into a local internet connection or connecting to the internet wirelessly. The wireless connection may use a cellular connection, any 802.11 standard or Bluetooth. The connection may be a direct point to point connection to a central receiver or multiple sensor units in an area may form a mesh network and share a single internet connection. After installation is complete the sensor unit is activated.

Next, in step 203, the installer/user runs a calibration application on a mobile device. The calibration application is used to collect measurement data as will be described in the following steps for each sensor unit once fixed in position. In step 204, the calibration application is used to provide the specific sensor unit to be calibrated with measurement data. This may be accomplished in any number of ways, entry of a sensor unit serial number read from the body of the sensor unit, scanning a barcode or QR code on the sensor unit, reading an RFID, unique identifier via Bluetooth, near field communication or other wireless communication.

Once the calibration application correctly identifies the sensor unit, the calibration application collects a sample image from the sensor unit in step 205. In an exemplary embodiment, the mobile device sends a request for the sample image to the cloud computer. The cloud computer requests the sample image from the sensor unit 101 over the internet and relays the sample image to the mobile device. In other embodiments the calibration unit may connect to and directly request the sample image from the sensor unit 101, which then sends a sample image to the sensor unit 101. The installer uses the sample image as a guide for the location to aim the mobile device when collecting images.

In step 206, the user orients the camera on the mobile device/calibration unit to take a first image that is substantially the same as the sample image. The calibration application uses a feature point matching algorithm, for example SIFT or SURF, to find tie points that match between the first image and the sample image. When a predetermined number of tie points are identified, the calibration application provides positive feedback to the user, such as by highlighting the tie point in the image or vibrating the phone or making a sound. In an exemplary embodiment, the tie points are identified and are distributed throughout the field of view of the sensor unit 101. In an exemplary embodiment at least 50 to 100 tie points are identified.

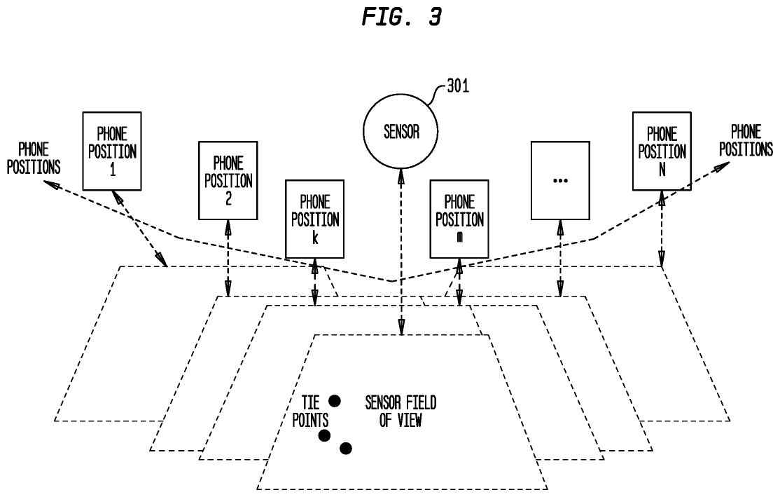

Upon receiving the positive feedback, in step 207 the calibration application preferably prompts the user to move the phone in a slow sweeping motion, keeping the camera oriented toward the sensor unit field of view (e.g., intersection). The sweeping process is illustrated in FIG. 3. The installer/user with the mobile device takes the first image and the calibration application identifies the tie points 303 that match with the sample image 302. The user then sweeps the mobile device through N mobile device positions. In an exemplary embodiment, the installer/user waves the phone from the maximum extension of his arm on one side to the maximum extension of his arm on the other side to complete the sweep. The user may also take the phone and walk a path along the outside of the sensor unit's field of view to complete the sweep. This process outputs Kn tie points where K is the number of matching tie points between each N and N−1 image.

In step 208, during the sweep the mobile device captures corresponding measurements of the mobile device's relative position to either the sample image or the previous image from the accelerometer, gyroscope and compass data. GPS coordinates may also be collected for each image.

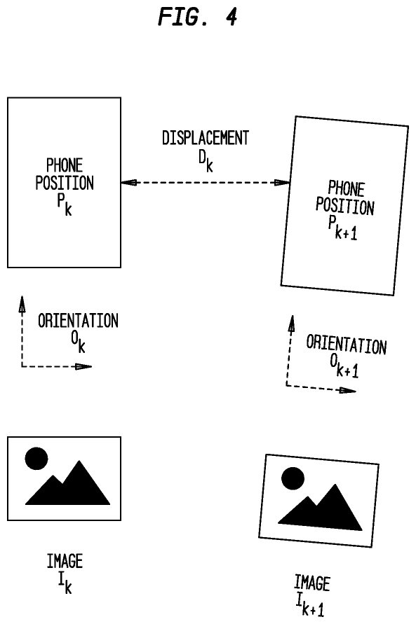

As illustrated by FIG. 4, there is a slight difference in the location of each image. This difference or displacement is used in the following steps to determine the relative location of each image. For each image collected during the sweep the calibration application performs an additional feature point matching at step 209 and ensures that a predetermined number of tie points are visible in each consecutive image along with the sample image in step 210. In an exemplary embodiment 50 to 100 tie points are identified.

If a predetermined number of matching tie points are not detected the calibration application instructs the user to re-orient the mobile device and perform an additional sweep 211. Afterwards, the process goes back to repeat step 208.

The installation is complete when a predetermined number of images and their corresponding measurements, from the accelerometer, gyroscope, compass etc., are collected 212. In an exemplary embodiment, at least 6 images are collected for the calibration. In alternate exemplary embodiments at least 6 to 12 images are collected.

In an exemplary embodiment, the sensor unit also obtains its longitude and latitude during the installation process. If the sensor unit does not include a GPS receiver the user may hold the mobile device adjacent to the sensor unit and the application will transmit GPS coordinates to the sensor unit. If neither the sensor unit nor the mobile device have a GPS sensor the longitude and latitude coordinates are determined later from a map and transmitted or entered into the sensor unit.

Once the calibration data including the N images, N corresponding measurements from the compass, N−1 corresponding measurements of the relative position of the mobile device are obtained from the accelerometer and gyroscope and Kn tie points are collected, a transform is created in the process phase. This transform converts the pixel coordinates of an object in an image into real world longitude and latitude coordinates.

In an exemplary embodiment, the calibration data is stored in the sensor unit or the cloud computer upon completion of the sensor unit calibration. The processing phase to calculate the transform is carried out on the sensor unit or the cloud computer. A structure from motion (SFM) algorithm may be used to calculate the 3D structure of the intersection. The relative position and orientation measurements of each image are used to align the SFM coordinate frame with an arbitrary real-world reference frame, such as East-North-Up (“ENU”), and rescale distances to a real-world measurement system such as meters or the like.

The GPS position of the sensor unit or an arbitrary point in the sample image is used as the origin to translate the real-world coordinates previously obtained into latitude and longitude coordinates. In an exemplary embodiment, the GPS position and other metadata is stored in the Sensor Database 118 in the cloud computer.

An exemplary SFM algorithm is dense multi-view reconstruction. In this example, every pixel in the image sensor's field of view is mapped to the real-world coordinate system.

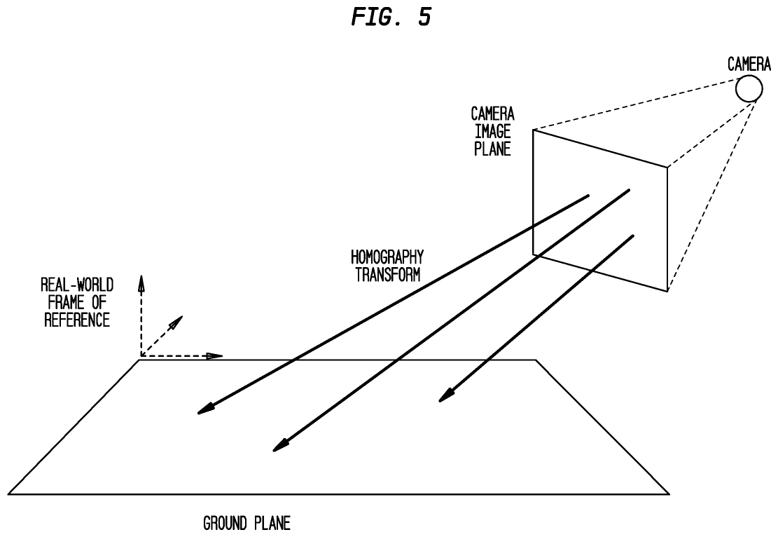

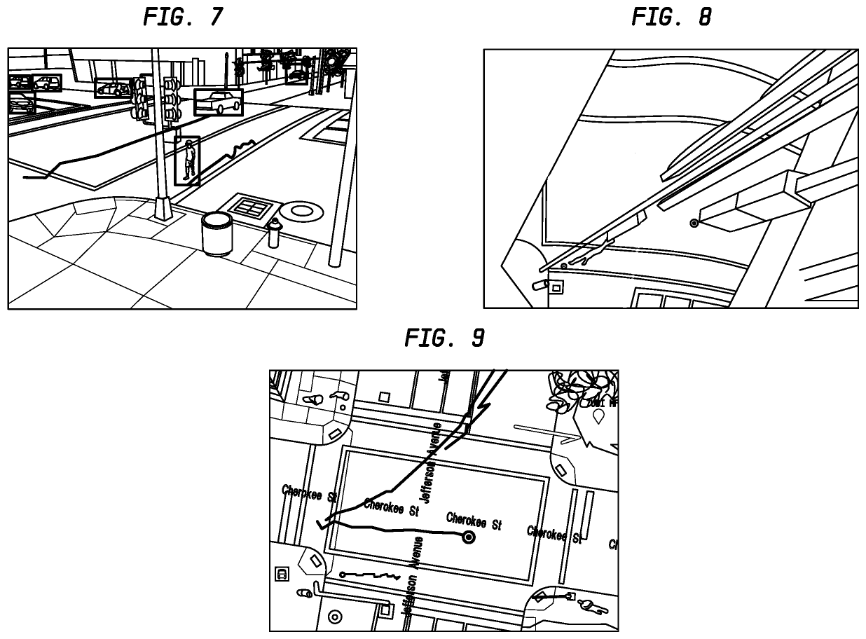

An additional exemplary SFM algorithm is a homography transform illustrated in FIG. 5. In this example, a plane is fit to tie points that are known to be on the ground. A convolutional neural network trained to segment and identify pixels on a road surface is used to distinguish between points that are on the ground and points associated with buildings, objects etc. Then a homography transform is used to transform any pixel coordinate to the real-world coordinate. FIG. 7 is an exemplary illustration of an image taken by the sensor unit. In this illustration, the objects already have bounding boxes and two of the objects have a path. The bounding box 701 identifies the location of the object on the ground plane as discussed further below. FIG. 8 is an example of a homography transform where FIG. 7 is projected onto the ground plane.

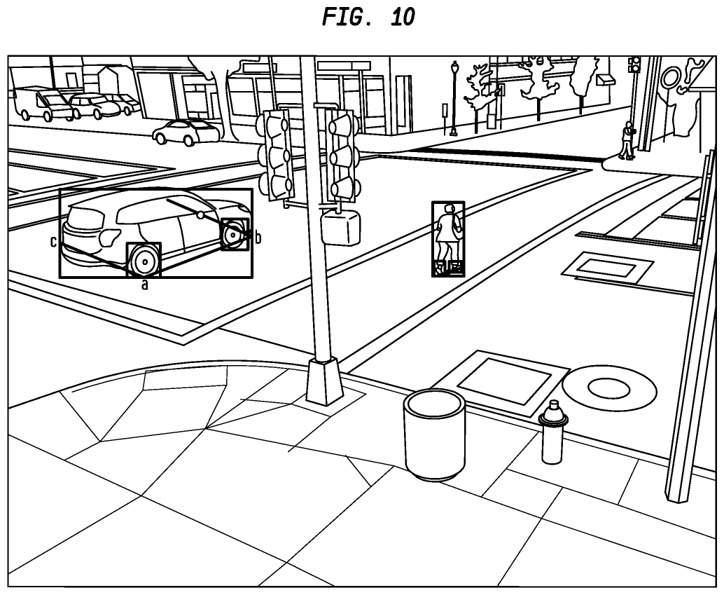

Once configured the sensor unit can track the path of distinct objects through each cell or intersection. FIG. 9 is an illustration of the paths of the objects outlined in FIG. 7 projected onto a satellite image of the intersection. The sensor unit can operate alone or in a network with other sensor units covering an area having an arbitrary size.

Detection and Tracking

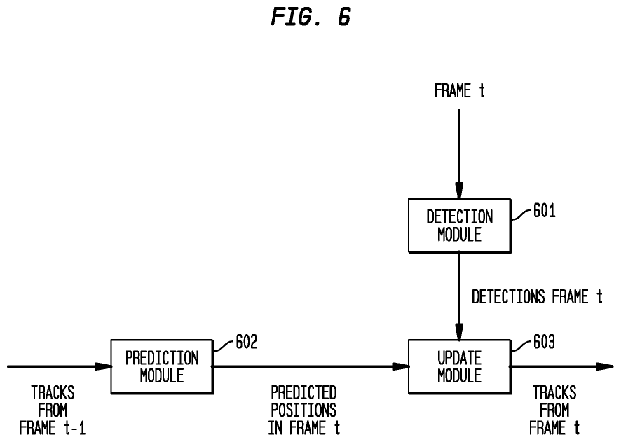

In an exemplary embodiment illustrated in FIG. 6, each sensor unit has at least three logical modules—a detection module, a prediction module and an update module. These modules work together to track the movement of objects through a specific intersection which the sensor unit observes. Each object is assigned a path which moves through the intersection. Each path includes identifying information such as the object's position, class label, current timestamp and a unique path ID.

The process of generating the path begins with the sensor unit taking a first image of the intersection at time t. FIG. 7 is an exemplary first image with a car and a person transiting the intersection.

Referring to FIG. 6, the detection module 601 begins by obtaining the first image and detecting and classifying the objects within the image. The detection module 601 includes a convolutional neural network pre-trained to detect different objects that transit the intersection. For example, objects may be classified as cars, pedestrians, or bicycles. The process used to identify the object and determine its location is discussed further below.

The prediction module 602 predicts the path of objects identified in a second frame from time t−1. The predicted path of an object is based on the previous path of an object and its location in the second frame. Exemplary prediction modules 602 include a naïve model (e.g. Kalman Filter), a statistical model (e.g. particle filter) or a model learned from training data (e.g. recurrent neural network). Multiple models can be used as the sensor unit collects historical data. Additionally, multiple models can be used simultaneously and later selected by a user based on their accuracy.

The update module 603 attempts to combine the current object and location information from the first frame with the predicted path generated from the prediction module. If the current location of an object is sufficiently similar to the predicted position of a path the current location is added to the path. If an object's current location does not match an existing path a new path is created with a new unique path ID.

In an exemplary embodiment, the sensor unit 101 transmits the path to the cloud computer 103 or other sensor units 101. The path may be transmitted after each iteration, at regular intervals (e.g. after every minute) or once the sensor unit 101 determines that the path is complete. A path is considered complete if the object has not been detected for a predetermined period of time or if the path took the object out of the sensor unit's field of view. The completion determination may be made by the cloud computer instead of the sensor unit.

The sensor unit 101 may transmit path data to the cloud computer 103 as a JSON text object to a web API over HTTP. Other transmission methods (e.g. MQTT) can be used. The object transmitted does not need to be text based.

Coordinate Transformation

FIG. 10 illustrates an exemplary method for determining the position of the object in real space. The detection module 601 uses a convolutional neural net or similar object detector to place a bounding box on an object in the intersection and detect the points where the object contacts the ground within the bounding box. The bounding box has a lower edge, a first vertical edge and a second vertical edge. The detection module 601 uses a homography transform to translate the points where the object touches the ground and the bounding box into real world coordinates.

Next the detection module 601, using the convolutional neural net, locates a point A where the object touches the ground and is near the bottom edge of the object bounding box. Then the detection module 601 locates a point B where the object touches the ground and is near the first vertical edge of the object bounding box. With the first and second points identified a line is drawn between them. A second line is drawn that intersects the point A and is perpendicular with the first line. A point C intersects the second line and the second vertical edge. Points A, B and C define a base frame for the object. The position of the object in real space is any point on the base frame.

Path Merging

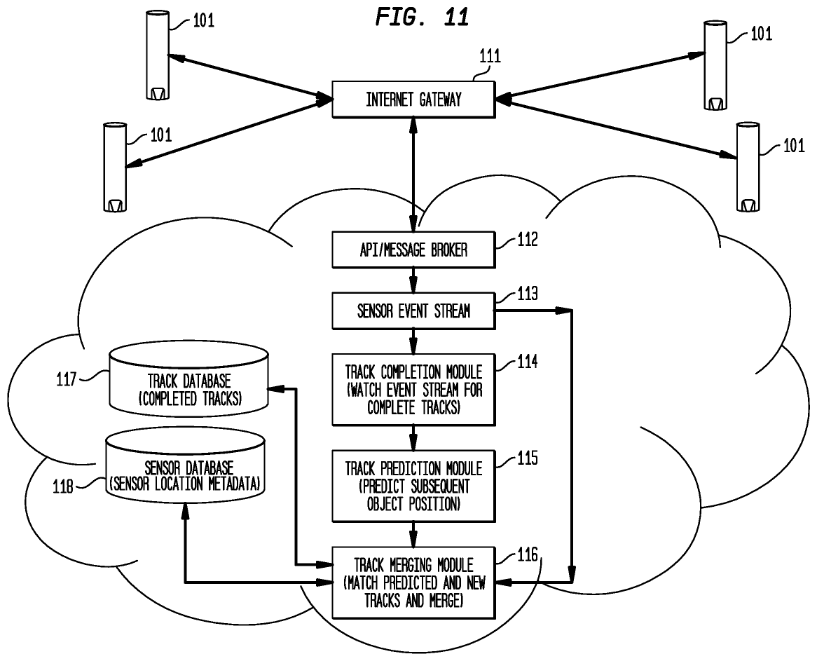

An exemplary method for tracking an object from a first intersection to a second intersection is illustrated in FIG. 11. Each path generated by a sensor unit is shared with a cloud computer or nearby sensor units. With this information the cloud computer or other nearby sensor units can merge paths from the first sensor unit to the second sensor unit.

As described above, an object's path is tracked while transiting the intersection. The tracking begins at time t1. While the following steps describe a cloud computer merging paths from a first sensor unit and a second sensor unit the process can be applied to a network of sensor units without a centralized cloud computer. The field of view on the ground of the sensor unit or the cell is modeled as a hexagon, square or any regular polygon. The objects predicted position is determined using a constant velocity model, using recurrent neural network or other similar method of time series prediction. An object's position is predicted based on the last known position of the object and the historical path of other similarly classified objects.

The cloud computer begins the process of merging paths by receiving data from the sensor units at the internet gateway 111 via an API or message broker 112. The sensor event stream 113 is the sequence of object identities and positions, including their unique path ID, transmitted to the cloud computer. A track completion module 114 in the cloud computer monitors the paths in the intersection. A track prediction module 115 predicts the next location of the object based on the process described above. When the predicted location of a first object lies outside the field of view of the first sensor unit at a time tn, if there are no adjacent monitored intersections that include the predicted location of the object, the path is completed. The completed path is stored in the Track Database 117.

If there exists a monitored second intersection including the predicted location of the first object, the cloud computer searches for a second object with an associated path to merge. The second object and the first object from the first intersection must have matching criteria for the merger to be successful. The matching criteria includes the second object and the first object having the same classification, the tracking of the second object began between times t1 and tn within the timeframe of the track predictions and the first position of the second object is within a radius r of the last known position of the first object. If the matching criteria is met a track merging module 116 merges the first object with the second object by replacing the second object's unique path ID with the first object's unique path ID.

The accuracy of the merging process is improved with the inclusion of object appearance information in addition to the identifying information. The object appearance information may include a histogram of oriented gradients or a convolutional neural network feature map.

If there are no tracked objects in the second intersection that meet the matching criteria of the first object, then the first path is completed.

If more than one object in the second intersection meet the matching criteria a similarity metric D (e.g. mean squared distance) is calculated for each object meeting the matching criteria in the second intersection. A matching object is selected from the plurality of objects in the second intersection, based on the similarity metric exceeding a predetermined threshold to merge with the first object.

The object appearance information may be incorporated into the similarity metric and the predetermined threshold. This improves accuracy when object mergers are attempted at a third, fourth or subsequent intersection.

If a plurality of matching objects have a similarity metric above the predetermined threshold, the object with the highest similarity metric is selected to merge with the first object. A high similarity metric is an indication that two objects are likely the same.

There exist additional methods of determining a matching object from a plurality of objects. The selecting process may be treated as a combinatorial assignment problem, in which the similarity of a first and second object by building a similarity matrix is tested. The matching object may also be determined by using the Hungarian algorithm or similar.

In an exemplary embodiment, the process of merging a first and second object from different intersections is performed interactively resulting in paths for the first object spanning an arbitrary number of sensor unit monitored intersections.

In some embodiments, the disclosed methods may be implemented as computer program instructions encoded on a non-transitory computer-readable storage media in a machine-readable format, or on other non-transitory media or articles of manufacture. In some examples, the signal bearing medium may encompass a computer-readable medium, such as, but not limited to, a hard disk drive, a Compact Disc (CD), a Digital Video Disk (DVD), a digital tape, memory. In some implementations, the signal bearing medium may encompass a computer recordable medium, such as, but not limited to, memory, read/write (R/W) CDs, R/W DVDs, etc. In some implementations, the signal bearing medium may encompass a communications medium, such as, but not limited to, a digital and/or an analog communication medium (e.g., a fiber optic cable, a waveguide, a wired communications link, a wireless communication link, etc.). Thus, for example, the signal bearing medium may be conveyed by a wireless form of the communications medium.

The non-transitory computer readable medium could also be distributed among multiple data storage elements, which could be remotely located from each other. The computing device that executes some or all of the stored instructions could be a sensor unit. Alternatively, the computing device that executes some or all of the stored instructions could be another computing device, such as a cloud computer.

It should be understood that this description (including the figures) is only representative of some illustrative embodiments. For the convenience of the reader, the above description has focused on representative samples of all possible embodiments, and samples that teach the principles of the disclosure. The description has not attempted to exhaustively enumerate all possible variations. That alternate embodiments may not have been presented for a specific portion of the disclosure, or that further undescribed alternate embodiments may be available for a portion, is not to be considered a disclaimer of those alternate embodiments. One of ordinary skill will appreciate that many of those undescribed embodiments incorporate the same principles of the disclosure as claimed and others are equivalent.

1. A method for tracking objects transiting an intersection by a sensor comprising:
acquiring an image from a first sensor, wherein the first sensor monitors a first cell;
classifying an object in the image;
detecting pixel coordinates of the object in the image;
transforming the pixel coordinates into a position in real space; and
updating a tracker with the position of the object.

2. The method of claim 1, wherein the transforming step is executed using a homography transform.

3. The method of claim 1, wherein the pixel coordinates of the object are determined by the locations where the first object touches the ground in the image.

4. The method of claim 1, wherein the classifying and detecting steps are accomplished by a convolutional neural network that identifies a class of the object and determines the pixel coordinates of the object.

5. The method of claim 1, wherein the position of the object in real space is determined by
transforming the points where the object touches the ground into ground plan coordinates;
generating an object bounding box that surround the object and has a lower edge, a first vertical edge and a second vertical edge;
transforming the object bounding box into ground plane coordinates;
locating a first point where the object touches the ground and is near the bottom edge of the object bounding box;
locating a second point where the object touches the ground and is near the first vertical edge of the object bounding box;
determining a first line between the first point and the second point;
determining a second line that intersects the first point and is perpendicular with the first line;
locating a third point that intersects with the second line and the second vertical edge;
defining a base frame of the object using the first, second and third points; and
defining the position of the object in real space as any point on the base frame.

6. The method of claim 1, further comprising:
predicting a path of a first object based on a tracker in a first cell;
matching the tracker to a second object in a second cell if the path leads to the second cell and meets a matching criteria;
terminating the tracker if the path does not lead to the second cell.

7. The method of claim 5, wherein the path is predicted based on at least one of a constant velocity model, a recurrent neural network, or a particle filter.

8. The method of claim 5, wherein the matching criteria includes the first object and the second object have the same class, the second object appeared in the second cell at a time that is consistent with the path and the second object is within a predetermined distance of a last known location of the first object.

9. The method of claim 5 further comprising:
calculating a similarity metric for each object in a plurality of objects when the plurality of objects meet the matching criteria;
selecting a matching object, from the plurality of objects, based on the similarity metric exceeding a predetermined threshold.

10. The method of claim 9 further comprising:
selecting the matching object, from the plurality of objects with a similarity metric above the predetermined threshold, with the highest similarity metric.

11. A method of calibrating a sensor for tracking objects transiting an intersection comprising:
mounting a sensor such that it can monitor a cell;
scanning a QR code on the sensor with a mobile device that identifies the specific sensor;
transmitting a request for an image to the sensor;
receiving an image from the sensor;
orienting a camera on the phone to capture the same image as the sensor;
capturing additional data including image, position, orientation and similar data from the mobile device;
produce a 3D structure from the additional data; and
a GPS position of the sensor or an arbitrary point is used as an origin to translate pixel coordinates into a position in real space.

12. The method of claim 11, wherein a feature point matching algorithm finds matching points between the image from the sensor and the image from the mobile device;
the mobile device indicates if enough matching points have been found in excess of a predetermined threshold; and
recapturing an image from the mobile device if the number of matching points does not meet a predetermined threshold.

13. The method of claim 12, wherein the additional data is captured by slowly sweeping the mobile device over the cell to be monitored and capturing information from an accelerometer, gyroscope, compass and image sensor on the mobile device;
the feature point matching algorithm finds matching points between consecutive images in the additional data; and
the mobile device requests an additional sweep of the cell if there are not enough matching points from the additional data to meet the predetermined threshold.

14. The method of claim 11, wherein the additional data also includes GPS data.

15. The method of claim 11, wherein a 3d structure is generated using a structure from motion algorithm.
